(19) United States
(12) Patent Application Publication
(10) Pub. No.: US 2026/0227151 A1
(43) Pub. Date: Aug. 6, 2026

(54) AN AIM SUPPORT AND A METHOD FOR USE OF THE SAME

(71) Applicant: Vorn Equipment AS, STAVANGER (NO)

(72) Inventor: Eirik ANDERSEN, STAVANGER (NO)

(73) Assignee: Vorn Equipment AS, STAVANGER (NO)

(21) Appl. No.: 19/147,816

(22) PCT Filed: Jan. 17, 2024
(86) PCT No.: PCT/NO2024/050010

§ 371 Date: Jul. 14, 2025

(30) Foreign Application Priority Data
Jan. 18, 2023 (NO) 20230043

(51) Int. Cl. F41C 33/00; F16M 13/04

(52) U.S. Cl. CPC F41C 33/001; F16M 13/04

(57) ABSTRACT

An aim support has a support part configured to be connected to an attachment part. The support part has a support face adapted to support an elbow, and a support body. The support body has a connecting part and a fastening part. The support face forms a fixed angle relative to the support body at the connecting part. The attachment part has a belt, and the support body is configured to be connected to the belt at the fastening part. The attachment part has an upper connection configured to connect the connecting part to the attachment part. The attachment part has one upper connection on one side of the support part and one upper connection on the opposite side thereof The upper connection has an elongated stabilizing organ between the connecting part and a portion of the belt.

### CROSS-REFERENCE TO RELATED APPLICATIONS

This application is the U.S. national stage application of International Application No. PCT/NO2024/050010, filed Jan. 17, 2024, which international application was published on Jul. 25, 2024, as WO 2024/155195 in the English language. The International Application claims priority to Norwegian Patent Application No. 20230043, filed on Jan. 18, 2023. The international application and Norwegian application are both incorporated herein by reference, in their entirety.

### FIELD

The present invention relates to an aim support. The aim support is intended to be mounted on a person around the person's abdomen and hip region. The aim support provides a support face for an elbow when the person is aiming a device at an object in a standing aim position. The device to be aimed may be a weapon, binocular, distance measurement device, camera, or other devices used for aiming.

### BACKGROUND

When a person is to aim a weapon at an object that is located at some distance, it is important that the weapon is kept steady with no or minimum movements. This is especially difficult in a standing aim position as available arm support is limited compared to a laying down position.

A variety of aiming rods are commercially available where the device being aimed rests on a rod that extends from the ground up to the device being aimed. This provides a vertical support. A drawback with this prior art is that there is no support in a horizontal plane. It is also inconvenient to have a rod that needs to be folded or stored when the person repositions between locations during for example hunting.

Document U.S. Pat. Nos. 6,336,576, 5,111,983 and US2009229162 discloses assemblies adapted to support an elbow of a person aiming a weapon or a camera. U.S. Pat. Nos. 4,991,758, 5,462,214 and CN102305986 discloses assemblies for supporting a camera during use.

Other proposed solutions comprise an arm support member attached to a rod that is attached to a belt located in the hip region. Examples of this is disclosed in documents U.S. Pat. Nos. 759,593, 6,009,655, and 6,082,034. The disclosed prior arts have in common that the rod is connected to the belt through a hinge type connection. To enable the hinged rod and the arm support member to provide a stable support for an arm without a risk of unintentional repositioning, the arm support member is required to be positioned at a distance away from the belt. The distance creates an angle between the rod and the arm to avoid the arm support member slipping on the supported arm. A disadvantage of this is that the arm support member supports the arm at a distance from the person's torso, causing a mass centre of the person aiming to shift away from a centre of the person. In precision aiming it is beneficial to keep the mass centre of the person aiming close to the centre of the person to have a stable standing aim position.

Another disadvantage is during application in for example hunting or photography scenarios where the person needs to move in and out of the standing aim position. The hinged rod may cause the arm support member to position itself in an unfavourable position during a critical period causing a poor-quality aim.

A third disadvantage is that during repositioning of the person to a new location, the rod and the arm support member hangs freely down from the belt in a thigh region or they are positioned in an upright position in front of the person restricting the movement of an arm or a thigh to some degree.

### SUMMARY

The present invention has for its object to remedy or to reduce at least one of the draw-backs of the prior art, or at least provide a useful alternative to prior art.

The object is achieved through features, which are specified in the description below and in the claims that follow. The invention is defined by the independent patent claims. The dependent claims define advantageous embodiments of the invention.

More specifically, the invention relates to an aim support comprising a support part configured to be connected when in use to an attachment part,
the support part comprises a support face adapted to support an elbow when the aim support is in use, and a support body;
the support body comprises at a first end portion a connecting part and at an opposite second end portion a fastening part;
the support face forms a fixed angle relative to the support body at the connecting part;
the attachment part comprises a belt, and the support body is configured to be connected when in use to the belt at the fastening part;
the attachment part comprises an upper connection configured to connect when in use the connecting part to the attachment part;
the attachment part comprises one upper connection on one side of the support part and one upper connection on the opposite side of the support part, wherein:
the upper connection comprises an elongated stabilizing organ between the connecting part and a portion of the belt.

The device to be aimed may be a weapon, a binocular, a distance measurement device, a camera, or other devices used for aiming.

The support part may comprise of a single rigid wire formed to form the support body and the support face. The support face may comprise a fabric material wrapped onto the rigid wire.

In an alternative embodiment, the support part may comprise a single block of a rigid or a semi rigid material formed to form the support body and the support face. The rigid or the semi rigid material may be a plastic material, a composite material or other suitable materials known in the art.

In another alternative embodiment, the support face may be hinged to the support body, where the support face may be locked into a position to form the fixed angle between the support face and the support body.

In another alternative embodiment, the support face may be detachable from the support body, where the support face may be attached to a fixture to form the fixed angle between the support face and the support body.

Materials in general have an elastic (non-permanent) deformation when a force is applied to the material. As a result of this, when the elbow is placed on the support face, the angle between the support face and the support body may deviate from an unloaded support face angle. The fixed angle as here described is considered fixed if the support face returns to the unloaded support face angle after the elbow is removed from the support face.

The support face has a size to safely support the elbow of the person aiming. The support face may be of a size that is as wide as it is long. The support face may be wider than it is long.

The connecting part may be a part connected to the support body or the support face.

The connecting part may be a clip, a ring, or a fabric material wrapped onto the support face. The connecting part may be other suitable connecting means known in the art.

In an alternative embodiment, the connecting part may be an integral part of the support body or the support face. The connecting part may be a slot, groove or other suitable connecting means known in the art.

The fastening part may be an integral part of the support body. The fastening part may be an end portion of the rigid wire that forms the support part, wherein the end portion slide into a groove in the belt. In another alternative embodiment the support body may have a profile that mates with a mating profile in the belt. The profile may be rectangular. The profile may be circular. The profile may have a complex shape comprising multiple geometries.

In an alternative embodiment, the fastening part may be a part connected to the support body. The fastening part may be a mating counterpart of a quick connection known in the art. The part may be other suitable means for connecting two parts known in the art.

The belt is adapted to be mounted around the person in an abdominal and hip region. The belt may comprise means for adjusting the length by an adjustable buckle, ladderlock, or other suitable means known in the art.

The upper connection may comprise an organ connecting the belt with the connecting part. The upper connection may comprise a part of the belt. The upper connection may comprise a stitching connecting the belt with the connecting part. The upper connection may comprise a mating quick connection known in the art connecting the belt with the connecting part. In embodiments of the aim support wherein the belt is wide and attached to the fastening part and the connecting part, the two upper connections are each defined as the part of the belt extending from each side of the support part.

In another alternative embodiment of the aim support, a long connection may connect the attachment part to the support part. The long connection may extend from the first end portion to the second end portion of the support body. The long connection in this embodiment performs the tasks of the fastening part and the connecting part. The second end portion of the long connection forms in this embodiment the fastening part. The first end portion of the long connection forms in this embodiment the connecting part. In an alternative embodiment, the long connection may extend sufficiently so the support face is supported horizontally and vertically when an elbow is resting on it.

A person skilled in the art will be able to design many alternative embodiments of the upper connection without departing from the scope of the appended claims.

The effect of the attachment part comprising the belt and two upper connections connecting the attachment part to the support part, is that the support face is supported horizontally and vertically when an elbow is resting on it.

The effect of the fixed angle between the support face and the support body is that no adjustments are required of the support face when the standing aim position is to be initiated. Another effect is that during a standing aim position, the elbow is positioned close to the centre of the person resulting in the mass centre of the person aiming being close to the centre of the person. This improves the quality of the aim.

The upper connection may comprise a fabric wherein the fabric is connected to the connecting part.

The upper connection may comprise a frame wherein the frame is connected to the connecting part.

The upper connections transfer a portion of the force applied to the support face from the elbow resting on the support face, to the belt. This provides support in the horizontal plane for the support face. This may be accomplished with the upper connection connected directly to the connecting part or the upper connection comprising the fabric or the frame that is connected to the connecting part.

The upper connection comprises an elongated stabilizing organ between the connecting part and a portion of the belt.

The elongated stabilizing organ may comprise a strap.

The elongated stabilizing organ may comprise a strap connected to a fabric wherein the fabric is connected to the connecting part.

The elongated stabilizing organ may comprise means for adjusting the length.

The portion of the belt where the elongated stabilizing organ is connected, may be located in an upper belt edge portion facing in the direction of the support face. The portion of the belt where the elongated stabilizing organ is connected, may be located in an inner belt face of the belt or an outer belt face of the belt. The portion of the belt where the elongated stabilizing organ is connected, may be located at a distance from the support part. The distance should be sufficient to enable the elongated stabilizing organ to transfer a portion of the force applied to the support face from the elbow resting on the support face, to the belt. The elongated stabilizing organ may be connected to the portion of the belt with a clip. The elongated stabilizing organ may be connected to the portion of the belt with stitching. The elongated stabilizing organ may be connected to the portion of the belt with other suitable means known in the art.

The elongated stabilizing organ may comprise a fabric strap. The elongated stabilizing organ may be a leather type strap. The elongated stabilizing organ may comprise a variety of materials forming the elongated stabilizing organ.

The means for adjusting the length of the elongated stabilizing organ may be done with an adjustable buckle, ladderlock, or other suitable means known in the art.

In an embodiment, the attachment part comprises the belt and two upper connections comprising the elongated stabilizing organs connecting the attachment part to the support part. The effect of this is the support face is provided with horizontal support and vertical support when the elbow is resting on the support face. Another effect is that the belt width may be reduced. A more narrow belt may transfer less movement from the upper torso to the resting arm used for aiming. The narrow belt may also reduce the weight of the aim support.

One of the effects of the elongated stabilizing organs is to transfer a portion of the force applied to the support face from the elbow resting on the support face, to the belt. This may be accomplished with the elongated stabilizing organ connected directly to the connecting part or the elongated stabilizing organ connected to a fabric that is connected to the connecting part.

The effect of the elongated stabilizing organ comprising the strap and means of adjusting the length is to improve the support in the horizontal direction for the support face when the aim support is mounted on the person.

An edge portion of the belt may form the elongated stabilizing organ.

As previously stated, the elongated stabilizing organs purpose is to transfer a portion of the force applied to the support face from the elbow resting on the support face, to the belt. In one embodiment, there may be a fabric in a gap between the elongated stabilizing organ and the belt. In this embodiment the elongated stabilizing organ and the belt may be considered as one wide belt wherein the edge portion of the belt form the elongated stabilizing organ.

In an alternative embodiment of the aim support, the belt may be so wide that the belt connects to the fastening part and the connecting part of the support part. In this embodiment the edge portion of the belt may form the elongated stabilizing organ.

The effect of the edge portion of the belt forming the elongated stabilizing organ is a less complex aim support in terms of parts and ease of use.

The support body may comprise two legs, the legs may be arranged in at least one of a parallel arrangement and an arrangement wherein the legs form a longer distance between them in the second end portion compared to the distance between them in the first end portion.

The legs may be in parallel or form a longer distance between them in the second end portion compared to the distance between them in the first end portion. The effect of the support body comprising two legs is improved lateral stability.

The aim support may comprise a storage device, wherein the support part may be positioned inside the storage device or the storage device may be attachable to the support part.

The support part may be adapted to provide a support for the storage device, wherein the support part may form at least one of a part of a storage device frame and the storage device frame.

The support part may be positioned inside the storage device and the support face may be accessible for the elbow on top of the storage device.

The effect of this is that the aim support may be used as a storage device. The storage device may be a bag such as a bumbag.

The support part, when positioned inside the storage device, may form, or at least form a part of a storage device frame.

In an alternative embodiment, the support part may form, or at least form a part of the storage device frame wherein the storage device may be attachable to the support part. The attachment means for the storage device may be a mating groove, a zipper or other suitable means known in the art.

A strap-member may be adapted to extend from a front edge portion of the storage device to the belt via and above a shoulder of the person using the aim support.

A strap-member may be adapted to extend from a support face edge portion to the belt via and above the shoulder of the person using the aim support

The effect of this is an additional support to the aim support if the storage device is heavy. The additional support may also aid in forming the fixed angle between the support body and the support face. The strap-member may comprise means of adjusting the length by suitable means known in the art.

In an alternative embodiment of the aim support, the strap-member may be adapted to extend from the front portion of the storage device, around a neck of the person and back to the front portion of the storage device.

In an alternative embodiment of the aim support, the strap-member may be adapted to extend from the support face edge portion, around the neck of the person and back to the support face edge portion.

The support face may comprise an anti-slip material.

The anti-slip material may be rubber, synthetic rubber, leather or other suitable materials known from the art that may increase friction between the support face and the person's clothing.

The effect of this is to reduce the probability of the elbow slipping when rested on the support face in a standing aim position.

In a second aspect the invention relates more particularly to a method for use of the aim support in that the method comprises the steps of:
providing an aim support;
position the belt around a torso in an abdominal and hip region and fasten the belt;
rotate the belt until the support part is positioned on a dorsal part of the torso;
in need, rotate the belt until the support part is positioned on a ventral part of the torso and in a ventral supportive position for an elbow; and
rest the elbow on the support face.

The aim support is intended to be carried in the abdomen and hip region. During a period when the aim support is not used as aim support, the belt may be rotated in the abdomen and hip region to allow the support part to be positioned in the dorsal part. The effect of this is the support part can be kept in a region on the body that will not interfere with activities as walking, climbing, etc. When the person encounters a situation that requires use of the aim support, the aim support may be rotated in the abdomen and hip region to position the support part in a position that allow an elbow to be supported by the support face. When the person wishes to enter a standing aim position, both hands can be kept on the device being aimed and the standing aim position can be entered with minimal movements reducing the possibility to frighten an animal during hunting or photography scenarios.

In embodiments of the aim support comprising one support face, the aim support may be rotated in the abdomen and hip region to position the support part in a position that allow an elbow to be supported by the support face independent on if the person is a right-handed or a left-handed person.

In an alternative embodiment, the aim support may comprise a wide support face, or two support faces to make it easier to use the aim support for both the right-handed and the left-handed person, or when aiming a device requiring two elbows to be rested, for example a camera.

### BRIEF DESCRIPTION OF THE DRAWINGS

In the following is described examples of preferred embodiments illustrated in the ac-companying drawings, wherein:

FIG. 1 shows an unfolded aim support;

FIG. 2 shows a side view of the same embodiment as in FIG. 1 mounted on a person in a ventral support position;

FIG. 3 shows the same embodiment as in FIGS. 1 and 2 mounted on the person in a dorsal position; FIG. 4 shows an unfolded aim support with an embodiment comprising a storage device;

FIG. 5 shows a side view of the same embodiment as in FIG. 4 mounted on the person in the ventral support position;

FIG. 6 shows the same embodiment as in FIGS. 4 and 5 mounted on the person in the dorsal position;

FIG. 7 shows an alternative embodiment of the aim support wherein the upper connection comprises a part of the belt; and

FIG. 8 shows an alternative embodiment of the aim support wherein the belt is more inclined relative to the horizontal direction then the upper connection in form of the elongated stabilizing organ, when the aim support is in use.

### DETAILED DESCRIPTION OF THE DRAWINGS

Any positional indications refer to the positions shown in the figures.

In the figures, same or corresponding elements are indicated by same reference numerals. For clarity reasons, some elements may in some of the figures be with-out reference numerals.

A person skilled in the art will understand that the figures are just principal drawings. The relative proportions of individual elements may also be distorted.

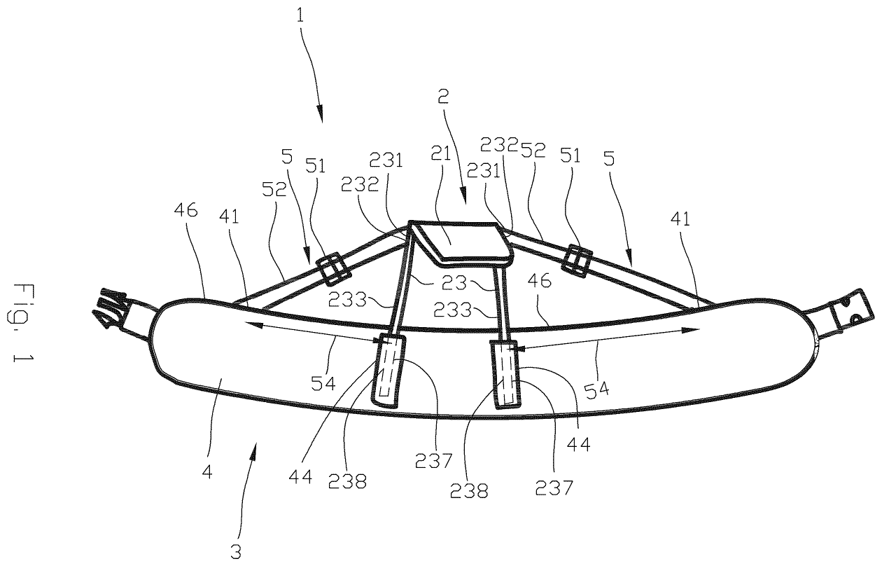

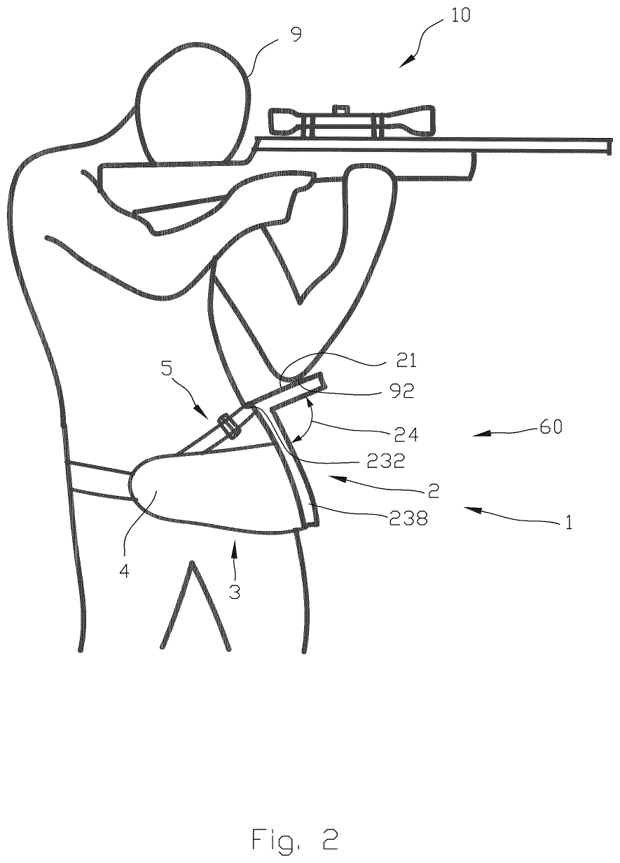

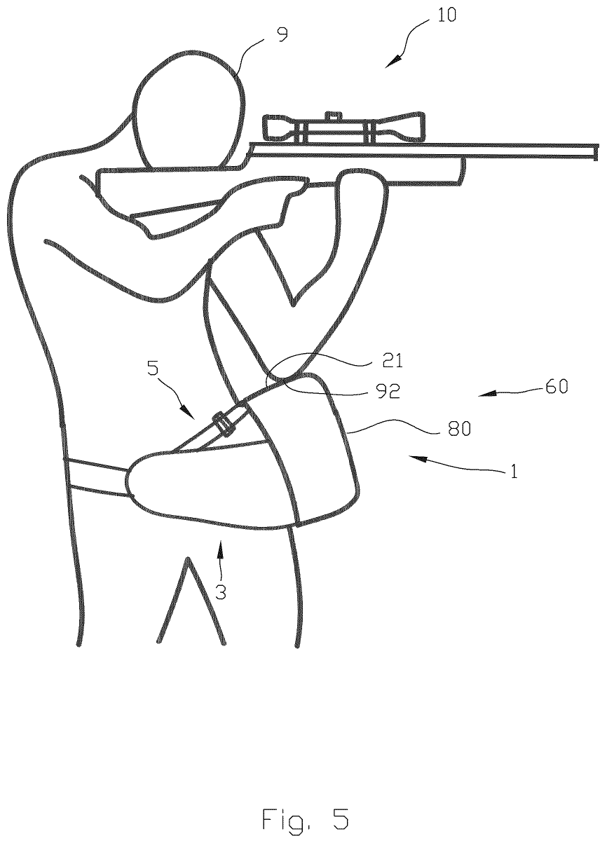

In FIG. 1 reference numeral 1 refers to an aim support. The aim support 1 comprises a support part 2 connected to an attachment part 3. The support part 2 comprises a support face 21 and a support body 23. In this embodiment the support body 23 comprises two support body legs 233 and the support face 21 is covered with a rubber, synthetic rubber or leather material to reduce the probability of slippage of the elbow 92 (see FIGS. 2 and 5) when rested on the support face 21. The support body 23 forms at a first end portion 231 a connecting part 232 and at an opposite second end portion 237 a fastening part 238. The fastening part 238 is in this embodiment formed by the end portions of the two support body legs 233. The dashed lines indicate the portion of the two support legs 233 that are hidden behind fabrics. The support body 23 forms a longer distance between the two support body legs 233 in the second end portion 237 compared to the distance between the two support body legs 233 in the first end portion 231.

As an alternative, the support body 23 may be formed with different shapes, such as a single wide rectangular element (not shown). In an alternative embodiment the support face 21 may be detachable from the support body 23 (not shown). In a further alternative embodiment, the support face 21 is hingedly attached to the support body 23 and kept in a support position by a locking device (not shown).

The support face 21 forms a fixed angle 24 relative to the support body 23 at the connecting part 232 as best shown in FIG. 2.

Referring again to FIG. 1, the attachment part 3 comprises a belt 4. The support body 23 is attached to the belt 4 at the fastening part 238. In this embodiment the attachment parts 238 are secured by two belt pockets 44 in the belt 4. The belt pockets 44 are fabrics stitched to the belt 4.

The attachment part 3 comprises an upper connection in form of an elongated stabilizing organ 5 connecting the connecting part 232 and a portion 41 of the belt 4. The portion 41 of the belt 4 is located at a distance 54 from the support part 2. The distance 54 is of a magnitude to safely transfer a portion of a force when the elbow 92 is resting on the support face 21, to the belt 4. A person skilled in the art will calculate the distance based on the materials used in the aim support 1, and the forces expected to be placed on the support face 21. In this embodiment the elongated stabilizing organs 5 are attached to an upper belt edge portion 46 facing in the direction of the support face 21. In another alternative embodiments (not shown), the elongated stabilizing organs 5 may be connected to an inner belt face of the belt 4 or to an outer belt face of the belt 4.

In an alternative embodiment there may be a rigid or a foldable member (not shown) between the connecting part 232 and the elongated stabilizing organ 5.

In the embodiment shown in FIG. 1 the elongated stabilizing organ 5 comprises a strap member 52 made of a fabric or leather with a means 51 for adjusting the length of the elongated stabilizing organ 5. The means 51 for adjusting the length of the elongated stabilizing organ 5 may be an adjustable buckle, ladderlock, or other suitable means known in the art.

The aim support 1 comprises one elongated stabilizing organ 5 on one side of the support part 2 and one elongated stabilizing organ 5 on the opposite side of the support part 2.

FIG. 2 shows the aim support 1 in a ventral support position 60. The aim support 1 aids in establishing a mass centre of a person 9 in a standing aim position 10 close to a centre of the person 9 when the standing aim position is established. The elongated stabilizing organ 5 transfer a portion of the force applied to the support face 21 from the elbow 92 resting on the support face 21, to the belt 4. The fastening part 238 supports the support face 21 in a vertical direction in addition to providing support in the horizontal direction.

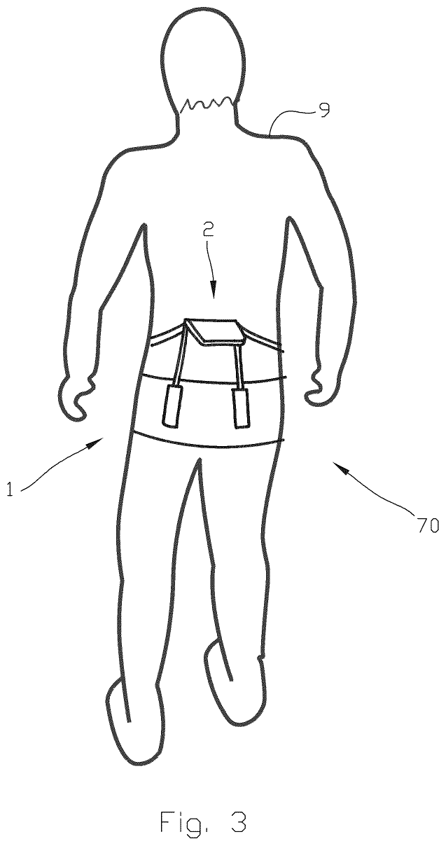

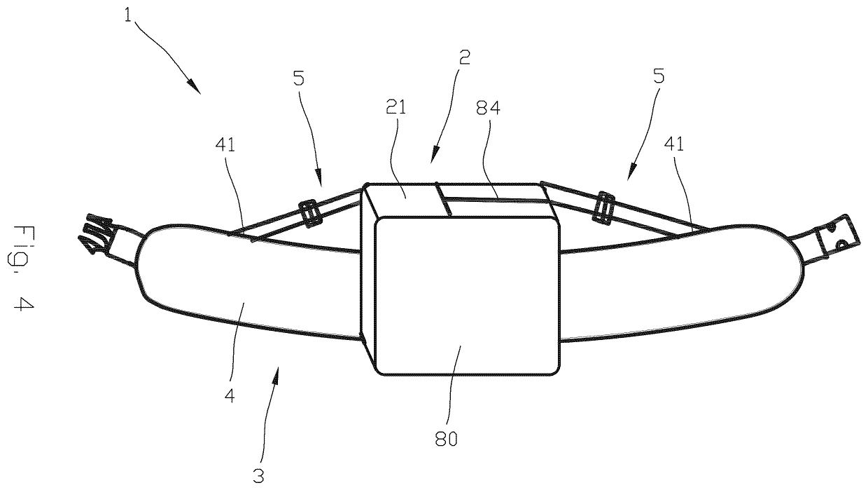

FIG. 3 shows the aim support 1 with the support part 2 positioned on a dorsal part of a torso 70. The arms of the person 9 are free to move without restrictions.

FIG. 4 shows an embodiment wherein the aim support 1 comprises a storage device 80. The storage device 80 may be a bumbag. The support part 2 is in this embodiment positioned inside the storage device 80. The support face 21 is accessible for the elbow 92 (not shown in FIG. 4) on top of the storage device 80. The support face 21 is covered with a rubber, a synthetic rubber or a leather material to reduce the probability of slippage of the elbow 92 when resting on the support face 21. The elongated stabilizing organs 5 are connected to a fabric or a storage device frame (not shown) that is connected to the support part 2. The elongated stabilizing organs 5 transfer a portion of the force applied to the support face 21 from the elbow 92 resting on the support face 21, to the belt 4 via the fabrics or storage device frame. The effect of this is that the support face 21 is supported in the horizontal direction. A zipper 84 forms an access to the interior of the storage device 80.

In an alternative embodiment (not shown), the support part 2 may be adapted to support the storage device 80 wherein the storage device 80 is connected to the support part 2.

FIG. 5 shows the aim support 1 in the ventral support position 60.

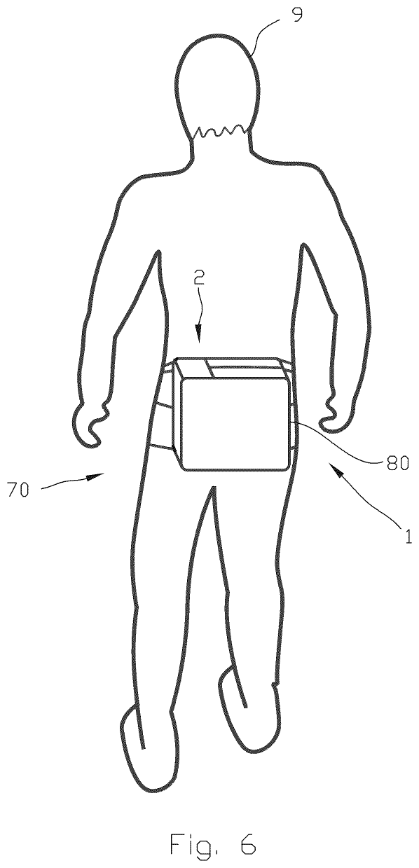

FIG. 6 shows the aim support 1 with the support part 2 and storage device 80 positioned on the dorsal part of the torso 70. The arms of the person 9 is free to move with-out restrictions.

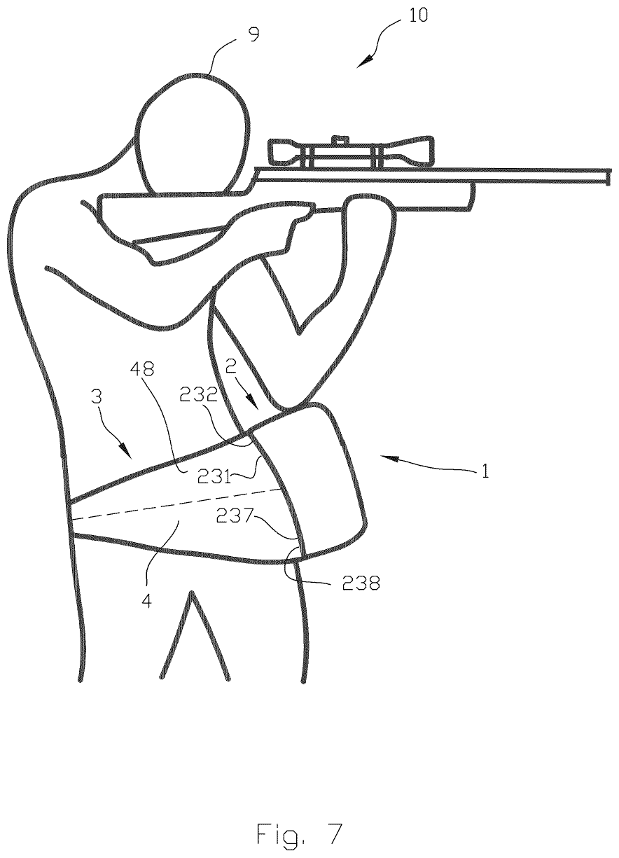

FIG. 7 shows an alternative embodiment of the aim support 1 wherein a part 48 of the belt 4 forms the upper connection. The dashed line indicates where the part 48 of the belt 4 ends. In this embodiment the belt 4 is so wide as it connects to the fastening part 238 and the connecting part 232 of the support part 2. The aim support 1 has a long connection (not shown) that connects the attachment part 3 to the support part 2. The long connection extends from the first end portion 231 to the second end portion 237 of the support body 23. The second end portion 237 of the long connection is in this embodiment the fastening part 238. The first end portion 231 of the long connection is in this embodiment the connecting part 232. An option for the embodiment in FIG. 7 is to not include the storage device 80 (not shown).

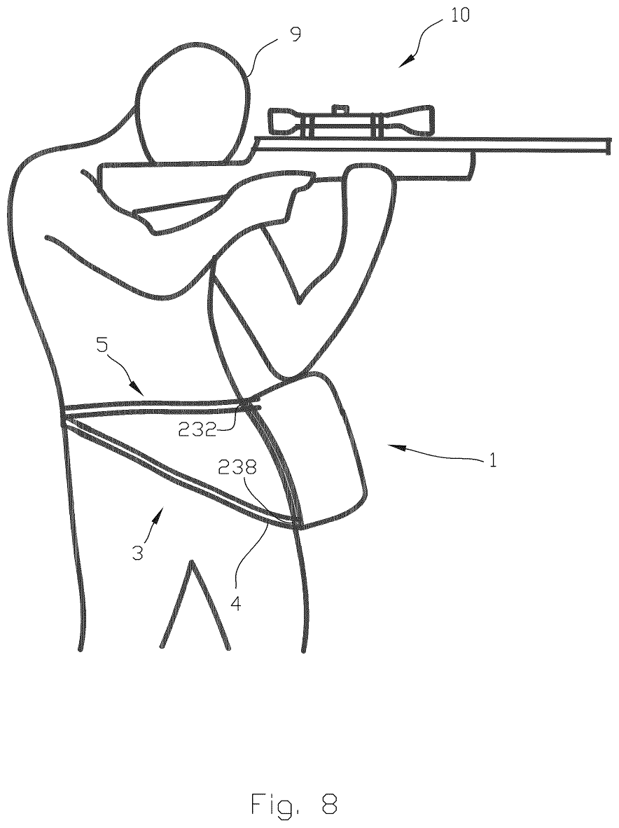

FIG. 8 shows an alternative embodiment of the aim support 1 wherein the belt 4 is more inclined relative to the horizontal direction then the upper connection in form of the elongated stabilizing organ 5. The aim support 1 comprises the same components and accomplishes the same technical effects as previous embodiments. An option for the embodiment in FIG. 8 is to not include the storage device 80 (not shown).

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements.

The mere fact that certain measures are recited in mutually different dependent claims does not indicate that a combination of these measures cannot be used to advantage.

1. An aim support comprising a support part configured to be connected when in use to an attachment part;
the support part comprises a support face adapted to support an elbow when the aim support is in use, and a support body;
the support body comprises at a first end portion a connecting part and at an opposite second end portion a fastening part;
the support face forms a fixed angle relative to the support body at the connecting part;
the attachment part comprises a belt, and the support body is configured to be connected when in use to the belt at the fastening part;
the attachment part comprises an upper connection configured to connect when in use the connecting part to the attachment part;
the attachment part comprises one upper connection on one side of the support part and one upper connection on the opposite side of the support part, wherein:
the upper connection comprises an elongated stabilizing organ between the connecting part and a portion of the belt.

2. The aim support according to claim 1, wherein the upper connection comprises a fabric wherein the fabric is connected to the connecting part

3. The aim support according to claim 1, wherein the upper connection comprises a frame wherein the frame is connected to the connecting part.

4. The aim support according to claim 1, wherein the elongated stabilizing organ comprises a strap.

5. The aim support according to claim 1, wherein the elongated stabilizing organ comprises a means for adjusting the length.

6. The aim support according to claim 1, wherein an edge portion of the belt comprises the elongated stabilizing organ.

7. The aim support according to claim 1, wherein the support body comprises two legs, the legs are arranged in at least one of a parallel arrangement and an arrangement wherein the legs form a longer distance between them in the second end portion compared to the distance between them in the first end portion.

8. The aim support according to claim 1, wherein the aim support comprises a storage device, wherein the support part is positioned inside the storage device or the storage device is attachable to the support part.

9. The aim support according to claim 8, wherein the support part is adapted to provide a support for the storage device, wherein the support part forms at least one of a part of a storage device frame and the storage device frame.

10. The aim support according to claim 8, wherein the support part is positioned inside the storage device and the support face is accessible for the elbow on top of the storage device.

11. The aim support according to claim 8, wherein a strap-member is adapted to extend from a front edge portion of the storage device to the belt via and above a shoulder during use of the aim support.

12. The aim support according to claim 1, wherein a strap-member is adapted to extend from a support face edge portion to the belt via and above the shoulder during use of the aim support.

13. The aim support according to claim 1, wherein the support face comprises an anti-slip material.

14. A method for use of the aim support according to claim 1, wherein the method comprises the steps of:
providing an aim support according to claim 1;
positioning the belt around a torso in an abdominal and hip region and fasten the belt;
rotating the belt until the support part is positioned on a dorsal part of the;
in need, rotating the belt until the support part is positioned on a ventral part of the torso and in a ventral supportive position for an elbow; and
resting the elbow on the support face.

15. The aim support according to claim 2, wherein the upper connection comprises a frame wherein the frame is connected to the connecting part.

16. The aim support according to claim 9, wherein the support part is positioned inside the storage device and the support face is accessible for the elbow on top of the storage device.

17. The aim support according to claim 9, wherein a strap-member is adapted to extend from a front edge portion of the storage device to the belt via and above a shoulder during use of the aim support.

18. The aim support according to claim 10, wherein a strap-member is adapted to extend from a front edge portion of the storage device to the belt via and above a shoulder during use of the aim support.
